(19) United States
(12) Patent Application Publication
(10) Pub. No.: US 2008/0297523 A1
(43) Pub. Date: Dec. 4, 2008

(54) IMAGE DISPLAY SYSTEM, GAME MACHINE, IMAGE DISPLAY METHOD, IMAGE DISPLAY PROGRAM, AND RECORDING MEDIUM

(75) Inventor: Shinichi TSUKAGOSHI, Azumino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/103,047

(22) Filed: Apr. 15, 2008

(30) Foreign Application Priority Data
May 28, 2007 (JP) 2007-140463

(51) Int. Cl. G06T 1/60

(52) U.S. Cl. 345/530

(57) ABSTRACT

An image display system includes: a background image transfer section which commands the image producing unit to produce a background image corresponding to the background image data and transfer the background image to the resolution adjusting unit; a window display image transfer section which commands the image producing unit to produce a window display image corresponding to the window display image data and transfer the window display image to the resolution adjusting unit; and a display control section which controls the process of the resolution adjusting unit for outputting the image stored in the virtual image storing unit.

The entire disclosure of Japanese Patent Application No. 2007-140463, filed May 28, 2007, is expressly incorporated by reference herein.

### BACKGROUND

1. Technical Field

The present invention relates to an image display system, a game machine, an image display method, an image display program, and a recording medium.

2. Related Art

A game machine such as a pinball machine which includes an image display system for displaying an image having a predetermined performance pattern is known (for example, see JP-A-2006-167092).

The image display system disclosed in JP-A-2006-167092 includes a display unit which displays an image, a CGROM (character generator read only memory) which stores image data for display, a VDP (video display processor) which produces an image corresponding to the image data stored in the CGROM, a display buffer which produces a virtual image corresponding to the image produced by the VDP, and other components. The VDP outputs an image signal corresponding to the image generated by the display buffer to the display unit, and the display unit displays the image in accordance with the image signal.

When the resolution of the image produced by the display buffer is different from the resolution of the display area of the display unit, the image signal outputted from the VDP is supplied to a device called scaler for controlling the resolution. The scaler converts the resolution of the image associated with the image signal outputted from the VDP into the same resolution as the resolution of the display area of the display unit, and outputs an image signal corresponding to the image after adjustment of the resolution.

A certain type of this image display system uses a display method for displaying a window image on a part of the display area of the display unit. According to this structure, the scaler produces an image having the same resolution as the resolution of the display area of the display unit with a monochrome image formed on the outer circumference of the window display image, and outputs an image signal corresponding to the image thus produced.

It is difficult, however, to produce a window display image having an attractive performance pattern when the image has a monochrome part on the outer circumference. In this case, the performance effect given by the displayed image decreases. Thus, there is a demand for producing an arbitrary background image display on the outer circumference of the window display image.

It is possible, for example, to display an arbitrary background display on the outer circumference of the window display image by an image display system having two image producing devices such as VDPs discussed above and GPUs (graphics processing units), and a scaler having dual input system. In this structure, a window display image is produced by one image producing device, and a background image is produced by the other image producing device. Then, image signals corresponding to these images are inputted to the scaler, and the scaler combines both the images. According to this structure, an arbitrary background image can be displayed on the outer circumference of the window display image.

However, this structure including two image producing devices and the dual input systems is complicated and increases the manufacturing cost.

### SUMMARY

It is an advantage of some aspects of the invention to provide an image display system, a game machine, an image display method, an image display 0program, and a recording medium, which are inexpensive and capable of displaying an arbitrary background image on the outer circumference of a window display image by a simple structure.

An image display system according to a first aspect of the invention includes: a display unit which displays an image; an image data storing unit which stores display image data; an image producing unit which produces an image corresponding to the image data stored in the image data storing unit; a virtual image storing unit which produces a virtual image corresponding to the image produced by the image producing unit and stores the virtual image; a resolution adjusting unit which adjusts resolution of the image stored in the virtual image storing unit and outputs the adjusted image to the display unit; and a control unit which controls the image producing unit and the resolution adjusting unit. Background image data for a background image displayed on a display area of the display unit and window display image data for a window image displayed on a part of the display area are stored in the image data storing unit. The control unit includes: a background image transfer section which commands the image producing unit to produce a background image corresponding to the background image data and transfer the background image to the resolution adjusting unit; a window display image transfer section which commands the image producing unit to produce a window display image corresponding to the window display image data and transfer the window display image to the resolution adjusting unit; and a display control section which controls the process of the resolution adjusting unit for outputting the image stored in the virtual image storing unit.

According to this structure, the control unit has the background image transfer section, the window display image transfer section, and the display control section. In this case, the image signal corresponding to the background image and the image signal corresponding to the window display image are separately transferred to the resolution adjusting unit in a time-separated manner. Then, the background image and the window display image transferred by the background image transfer section and window display image transfer section are stored in the virtual image storing unit of the resolution adjusting unit with the window display image overwritten on the background image. That is, the background image and the window display image are combined and stored in the virtual image storing unit.

Accordingly, the image display system can display an arbitrary background image on the outer circumference of a window display image by the simple structure including one image producing unit (image producing device) and the resolution adjusting unit (scaler) having one input system.

It is preferable that the background image transfer section commands the image producing unit to produce an entire background image having resolution determined according to the resolution of the entire display area of the display unit and transfer the entire background image to the resolution adjusting unit.

Each of the image producing device such as VDP and GPU and the scaler described above outputs an image signal according to predetermined dot clock (operation clock). The refresh rate of an image associated with the image signal outputted from the image producing device or the scaler varies in accordance with the dot clock and resolution of the image.

It is necessary to design the image display system such that the refresh rate of the image associated with the image signal outputted from the image producing device becomes equivalent to the refresh rate of the image associated with the image signal outputted from the scaler. This is required because the scaler cannot output a normal image signal to the display unit when the refresh rates of the images corresponding to the image signals outputted from the image producing device and the scaler are different from each other.

More specifically, when the refresh rate of the image associated with the image signal outputted from the image producing device is higher than the refresh rate of the image associated with the image signal outputted from the scaler, for example, an image signal corresponding to image data for the next one frame is outputted from the image producing device before an image signal corresponding to image data for the current one frame is outputted from the scaler to the display unit. Thus, the scaler cannot output a normal image signal to the display unit.

On the other hand, when the refresh rate of the image associated with the image signal outputted from the image producing device is lower than the refresh rate of the image associated with the image signal outputted from the scaler, for example, an image signal corresponding to image data for the current one frame is not yet outputted from the image producing device when an image signal corresponding to image data for the current one frame is outputted from the scaler to the display unit. Thus, the scaler cannot output a normal image signal to the display unit.

The image displayed on the display area by the display unit based on an abnormal image signal outputted from the scaler becomes a disordered image.

Thus, in the structure where the dot clock of the image producing device is designed such that the refresh rate of the image associated with the image signal outputted from the image producing device becomes equivalent to the refresh rate of the image outputted from the scaler at the time of outputting the image signal corresponding to the window display image, for example, the refresh rate of the image associated with the image signal outputted from the image producing device becomes lower when an image signal corresponding to the background image having larger resolution than that of the window display image is outputted from the image producing device. That is, when the background image is transferred from the background image transfer section of the image display system according to the first aspect of the invention, the refresh rates of the images associated with the image signals outputted from the image producing device and the scaler are different from each other. In this case, the display unit displays a disordered image.

However, the background image transfer section of the image display system according to the first aspect of the invention produces the entire background image having resolution determined according to the resolution of the entire display area of the display unit, and thus can transfer the entire background image to the resolution adjusting unit at a time. Then, the window display image is transferred after the entire background image is transferred by the background image transfer section. Thus, in such a structure which stops the output of the image signal from the scaler during the period of transferring the entire background image by the background image transfer section, for example, the display unit can display only a normal image without a disordered image.

As described above, the entire background image having resolution determined according to the resolution to the entire display area of the display unit is produced. Thus, when the resolution is increased to twice larger resolution by the scaler, the entire background image having half of the resolution of the entire display area of the display unit is produced.

It is preferable that the background image transfer section commands the image producing unit to produce division background images created by dividing the background image and transfer the division background images to the resolution adjusting unit.

In this case, it is possible to produce the division background images by using the image producing unit by storing division background image data as a plurality of divided parts in the image data storing unit in advance and producing the division background images corresponding to the division background image data, for example. It is also possible to produce the division background images by dividing the background image data stored in the image data storing unit into a plurality of parts and extracting the parts by using the image producing unit.

According to this structure, the division background image data divided into plural parts is stored in the image data storing unit in advance, for example. Thus, the storage area of the image data storing unit can be more effectively used than in the structure where large background image data is stored without division. That is, large background image data which requires a large continuous region in a storage area of the image data storing unit can be stored in small continuous regions when the image data are divided. Thus, the storage area of the image data storing unit can be effectively used.

Alternatively, the division background images are produced by dividing the background image data stored in the image data storing unit into plural parts and extracting the plural parts by using the image producing unit, for example. In this case, the image producing unit can reduce the storage area to be provided for the display buffer. More specifically, the image producing unit provides a storage area to the display buffer according to resolution of an image to be produced, and the display buffer produces a virtual image corresponding to the image produced in the storage area thus provided. For example, in the structure where the image producing unit provides the storage area to the display buffer according to the resolution of the window display image, the display buffer cannot produce a virtual image corresponding to a background image having larger resolution than that of the window display image in the provided storage area. However, when the image producing unit divides the background image data into a plurality of parts and extracts the plural parts according to the provided storage area to produce division background images, the display buffer can produce virtual images corresponding to the division background images in the provided storage area. Thus, the image producing unit can reduce the storage area to be provided for the display buffer, and can effectively use the storage area dedicated for the display buffer.

It is preferable that the display control section commands the resolution adjusting unit to stop the process of outputting the image stored in the virtual image storing unit when the background image is transferred by the image producing unit.

According to this structure, the display control section commands the resolution adjusting unit to stop output of the image stored in the virtual image storing unit when the background image is transferred by the background image transfer section. Thus, the display unit can display only a normal image without a disordered image.

A game machine according to a second aspect of the invention includes the image display system described above.

According to this structure, operation and advantage similar to those of the above image display system can be offered.

An image display method used for an image display system according to a third aspect of the invention includes: a display unit which displays an image; an image data storing unit which stores display image data; an image producing unit which produces an image corresponding to the image data stored in the image data storing unit; a virtual image storing unit which produces a virtual image corresponding to the image produced by the image producing unit and stores the virtual image; a resolution adjusting unit which adjusts resolution of the image stored in the virtual image storing unit and outputs the adjusted image to the display unit; and a control unit which controls the image producing unit and the resolution adjusting unit. The control unit performs a background image transfer step which produces a background image corresponding to background image data for a background image displayed on a display area of the display unit and transfers the background image to the resolution adjusting unit, a window display image transfer step which produces a window display image corresponding to window display image data for a window image displayed on a part of the display area and transfers the window display image to the resolution adjusting unit, and a display control step which controls the process of the resolution adjusting unit for outputting the image stored in the virtual image storing unit.

According to this structure, operation and advantage similar to those of the above image display system can be offered.

An image display program used for an image display system according to a fourth aspect of the invention includes: a display unit which displays an image; an image data storing unit which stores display image data; an image producing unit which produces an image corresponding to the image data stored in the image data storing unit; a virtual image storing unit which produces a virtual image corresponding to the image produced by the image producing unit and stores the virtual image; a resolution adjusting unit which adjusts resolution of the image stored in the virtual image storing unit and outputs the adjusted image to the display unit; and a control unit which controls the image producing unit and the resolution adjusting unit. The program allows the control unit to perform a background image transfer step which produces a background image corresponding to the background image data for a background image displayed on a display area of the display unit and transfers the background image to the resolution adjusting unit, a window display image transfer step which produces a window display image corresponding to the window display image data for a window image displayed on a part of the display area and transfers the window display image to the resolution adjusting unit, and a display control step which controls the process of the resolution adjusting unit for outputting the image stored in the virtual image storing unit.

A storage medium according to a fifth aspect of the invention is a storage medium on which the image display program described above is recorded in such a manner as to be readable by a computer.

According to this structure, operation and advantage similar to those of the above image display system can be offered.

### BRIEF DESCRIPTION OF THE DRAWINGS

The invention will be described with reference to the accompanying drawings, wherein like reference numbers are given to like elements.

FIG. 1 is a block diagram showing a general structure of a pinball machine according to a first embodiment.

FIG. 2 is a flowchart showing image display process performed by an image display system according to the first embodiment.

FIGS. 3A and 3B illustrate virtual images produced by a frame buffer according to the first embodiment.

FIG. 4 is a block diagram showing a general structure of a pinball machine according to a second embodiment.

FIG. 5 is a flowchart showing image display process performed by an image display system according to the second embodiment.

FIGS. 6A to 6D illustrate virtual images produced by a frame buffer according to the second embodiment.

### DESCRIPTION OF EXEMPLARY EMBODIMENTS

### First Embodiment

A first embodiment according to the invention is hereinafter described with reference to the drawings.

### General Structure of Pinball Machine

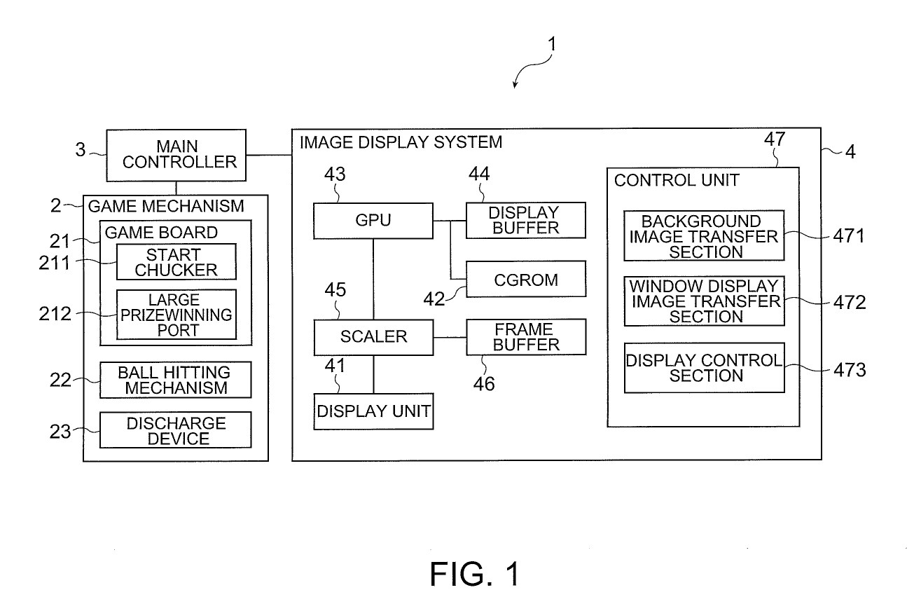

FIG. 1 is a block diagram showing a general structure of a pinball machine 1.

The pinball machine 1 is a game machine which discharges a predetermined number of game balls when a game ball hit onto a game board by the operation of a player playing the pinball machine 1 enters a prizewinning port provided on the game board. The pinball machine 1 includes a game mechanism 2, a main controller 3, and an image display system 4 as illustrated in FIG. 1.

The game mechanism 2 has a game board 21, a ball hitting mechanism 22, and a discharge device 23.

Though not shown in the figure, the game board 21 has a plurality of pins, pinwheels, and other equipment disposed on the game surface (surface on the game playing person side) for guiding a game ball, and prizewinning ports disposed at predetermined positions such as a start chucker 211 which commands the main controller 3 to execute lottery process when a game ball wins a prize, and a large prizewinning port (attacker) 212 which opens when a winning number is drawn in the lottery process executed by the main controller 3. The game surface has an opening, and a display area of a display unit 41 which is included in the image display system 4 and will be described later is exposed through this opening.

The ball hitting mechanism 22 is a system which hits game balls onto the game board 21, and has a rotatable handle, a motor capable of hitting game balls onto the game board 21 by force in accordance with the rotation angle of the handle, and other components.

The discharge device 23 discharges the predetermined number of game balls when a game ball enters any of the prizewinning ports such as the start chucker 211 and the large prizewinning port 212.

The main controller 3 has a CPU (central processing unit), and other components, and has functions of performing the lottery process discussed above and controlling the entire pinball machine 1. The main controller 3 outputs a control command corresponding to the result of the lottery process to the image display system 4 such that the image display system 4 can display an image having performance pattern such as animated cartoon corresponding to the result of the lottery process. In this step, image display process for producing a window display image having performance pattern such as animated cartoon, and an arbitrary background image positioned on the outer circumference of the window display image can be executed in response to the predetermined control command inputted to the image display system 4. This image display process will be described in detail later.

The image display system 4 displays an image having predetermined performance pattern such as animated cartoon in response to the control command issued from the main controller 3, and has the display unit 41, a CGROM 42, a GPU 43, a display buffer 44, a scaler 45, a frame buffer 46, and a control unit 47.

The display unit 41 has a liquid crystal panel and a backlight, and displays an image corresponding to an image signal inputted from the scaler 45 on a predetermined display area. The display area of the display unit 41 is exposed through the opening formed on the game surface of the game board 21, and thus the person playing the pinball machine 1 can see the image displayed on the display area of the display unit 41 through the opening of the game board 21. In this embodiment, the resolution of the display area of the display unit 41 is 1,280×960 (horizontal 1,280 pixels×vertical 960 lines).

The display unit 41 is not limited to the structure having the liquid crystal panel and backlight, but may be a structure having organic EL (electro luminescence) element or the like.

The CGROM 42 as an image data storing unit stores image data for display, where entire background image data for an entire background image having the same resolution as the resolution of the entire display area of the display unit 41, and window display image data for a window image displayed on a part of the display area of the display unit 41 are stored. The window display image data contains character image data such as characters and pictures, still image data to be combined with the character image data, and other data.

The GPU 43 as an image forming unit produces an image corresponding the image data stored in the CGROM 42, and outputs an image signal corresponding to the produced image to the scaler 45. More specifically, the GPU 43 produces an image for one frame based on the image data stored in the CGROM 42 under the control of the control unit 47, and commands the display buffer 44 to produce a virtual image corresponding to the produced image and store the virtual image. The display buffer 44 stores the virtual image corresponding to the image produced by the GPU 43, and the GPU 43 outputs an image signal corresponding to the image stored in the display buffer 44 to the scaler 45.

The GPU 43 has a not-shown crystal oscillator, and outputs an image signal in accordance with dot clock based on the output from the crystal oscillator. In this embodiment, the dot clock of the GPU 43 is approximately 37 MHz. The refresh rate of the image associated with the image signal outputted from the GPU 43 is determined by the dot clock and the horizontal cycle and vertical cycle of the image signal.

The horizontal cycle is the sum of the output period of an image signal corresponding to image data of pixels for one line in the horizontal direction, and the horizontal blanking period containing a horizontal synchronous signal for achieving synchronization at the time of producing a virtual image. The horizontal cycle is represented by the number of pixels. Thus, the pixel number of the horizontal cycle contains the number of pixels corresponding to the horizontal blanking period, and therefore needs to be set at a number larger than the number of pixels in the horizontal direction contained in the image associated with the image signal.

The vertical cycle is the sum of the output period of an image signal corresponding to image data of pixels for one frame in the vertical direction, and the vertical blanking period containing a vertical synchronous signal for achieving synchronization at the time of producing a virtual image. The vertical cycle is represented by the number of lines. Thus, the line number of the vertical cycle contains the number of lines corresponding to the vertical blanking period, and therefore needs to be set at a number larger than the number of lines in the vertical direction contained in the image associated with the image signal.

The horizontal cycle, the vertical cycle and the resolution of the image in the GPU 43 are set by a control unit 47 described later.

When the horizontal cycle and the vertical cycle are set at 998 pixels and 618 lines, respectively, for example, the dot clock of the GPU 43 becomes approximately 37 MHz. Thus, the refresh rate of the image corresponding to the image signal outputted from the GPU 43 is approximately 60 Hz. In this case, the resolution of the image produced by the GPU 43 can be set at 800×600.

When the horizontal cycle and vertical cycle are set at 1,408 pixels and 989 lines, respectively, the dot clock of the GPU 43 becomes approximately 37 MHz. Thus, the refresh rate of the image corresponding to the image signal outputted from the GPU 43 is approximately 26.7 Hz. In this case, the resolution of the image produced by the GPU 43 can be set at 1,280×960.

Thus, when the dot clock of the GPU 43 is fixed, the refresh rate of the image associated with the image signal outputted from the GPU 43 lowers as the resolution of the image produced by the GPU 43 increases.

The scaler 45 as a resolution adjusting unit controls the resolution of the image associated with the inputted image signal and outputs the adjusted resolution to the display unit 41. More specifically, the scaler 45 commands the frame buffer 46 to produce a virtual image corresponding to the image associated with the image signal outputted from the GPU 43 and store the virtual image under the control of the control unit 47. That is, the frame buffer 46 as a virtual image storing unit produces a virtual image corresponding to the image produced by the GPU 43 and stores the virtual image. Then, the scaler 45 controls the resolution of the image stored in the frame buffer 46, and produces an image signal corresponding to the image having the resolution after adjustment to be outputted to the display unit 41.

Similarly to the GPU 43, the scaler 45 has a not-shown crystal oscillator, and outputs an image signal in accordance with dot clock based on the output from the crystal oscillator. In this embodiment, the dot clock of the scaler 45 is approximately 83.25 MHz. The refresh rate of the image associated with the image signal outputted from the scaler 45 is determined by the dot clock and the horizontal cycle and vertical cycle of the image signal.

When the horizontal cycle and vertical cycle of the image signal outputted from the GPU 43 are set at 998 pixels and 618 lines, respectively, the resolution of the image becomes 800×600. Then, the scaler 45 commands the frame buffer 46 to produce a virtual image corresponding to the image having the resolution of 800×600 in synchronization with the dot clock of the GPU 43 and the horizontal synchronous signal and vertical synchronous signal contained in the image signal inputted from the GPU 43, and store the virtual image. Thereafter, the scaler 45 converts the resolution of the image stored in the frame buffer 46 into the same resolution as the resolution of the display area of the display unit 41, i.e., the resolution of 1,280×960, and then generates an image signal corresponding to the image after resolution adjustment and outputs the image signal to the display unit 41.

When the horizontal cycle and vertical cycle are set at 1,408 pixels and 989 lines, respectively, for example, the refresh rate of the image associated with the image signal outputted from the scaler 45 becomes approximately 60 Hz. In this case, the resolution of the image adjusted by the scaler 45 can be set at the same resolution as the resolution of the display area of the display unit 41, i.e., 1,280×960.

The horizontal cycle and vertical cycle of the scaler 45, and the resolution of the image are established by the control unit 47 which will be described later. In this embodiment, the control unit 47 sets the horizontal cycle and vertical cycle of the image signal outputted from the scaler 45 at 1,408 pixels and 989 lines, respectively, and establishes the resolution of the image adjusted by the scaler 45 at 1,280×960 in the same manner as in the above example.

The control unit 47 constituted by not-shown CPU, memory and the like controls the entire image display system 4 as well as the GPU 43 and the scaler 45, and has a background image transfer section 471, a window display image transfer section 472, and a display control section 473. The memory contains an image display program for performing image display process which will be described later.

The background image transfer section 471 commands the GPU 43 to produce an entire background image corresponding to entire background image data stored in the CGROM 42 and transfer the produced entire background image to the scaler 45. More specifically, the background image transfer section 471 sets the horizontal cycle and vertical cycle of the image signal outputted from the GPU 43 at 1,408 pixels and 989 lines, respectively, and the resolution of the image produced by the GPU 43 at 1,280×960. Then, the background image transfer section 471 commands the GPU 43 to produce an entire background image having the same resolution as the resolution of the entire display area of the display unit 41, i.e., 1,280×960, and transfer this entire background image to the scaler 45. That is, the background image transfer section 471 commands the GPU 43 to produce the entire background image having resolution determined according to the resolution in the entire display area of the display unit 41. In this case, the refresh rate of the image associated with the image signal outputted from the GPU 43 is approximately 26.7 Hz as discussed above.

The window display image transfer section 472 commands the GPU 43 to produce a window display image corresponding to window display image data stored in the CGROM 42 and transfer this window display image to the scaler 45. More specifically, the window display image transfer section 472 sets the horizontal cycle and vertical cycle of the image signal outputted from the GPU 43 at 998 pixels and 618 lines, respectively, and sets the resolution of the image produced by the GPU 43 at 800×600. Then, the window display image transfer section 472 commands the GPU 43 to produce a window display image having resolution of 800×600 which is smaller than the resolution of 1,280×960 of the display area of the display unit 41, and transfer the produced window display to the scaler 45. In this case, the refresh rate of the image associated with the image signal outputted from the GPU 43 is approximately 60 Hz as discussed above.

The display control section 473 controls the process of the scaler 45 for outputting the image stored in the frame buffer 46.

More specifically, the display control section 473 commands the scaler 45 to stop outputting the image stored in the frame buffer 46 when the entire background image is transferred from the GPU 43 to the scaler 45 under the control of the background image transfer section 471. This step is required since the refresh rate of the image associated with the image signal outputted from the GPU 43 (approximately 26.7 Hz as discussed above) is different from the refresh rate of the image associated with the image signal outputted from the scaler 45 (approximately 60 Hz as discussed above). When the refresh rate of the GPU 43 is different from that of the scaler 45, the saler 45 cannot output a normal image signal to the display unit 41. An image displayed by the display unit 41 based on an abnormal image signal outputted from the scaler 45 becomes a disordered image.

When the window display image is transferred from the GPU 43 to the scaler 45 under the control of the window display image transfer section 472, the display control section 473 commands the scaler 45 to start outputting the image stored in the frame buffer 46. This step can be executed since the refresh rate of the image associated with the image signal outputted from the GPU 43 is substantially the same as the refresh rate of the image associated with the image signal outputted from the scaler 45 (approximately 60 Hz) as discussed above. In this case, the scaler 45 can output a normal image signal to the display unit 41. When the scaler 45 outputs the image signal to the display unit 41 under the control of the display control section 473, the display unit 41 displays an image corresponding to the image signal outputted from the scaler 45 on the predetermined display area.

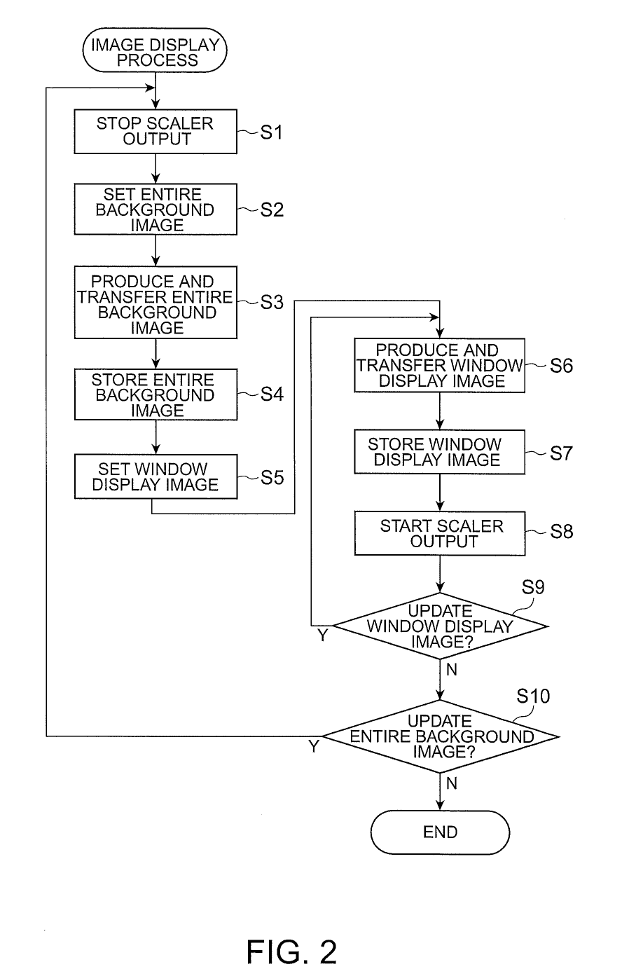

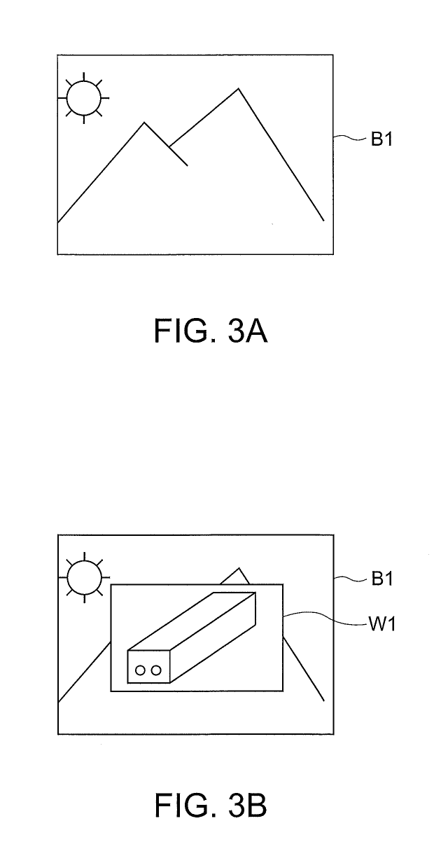

An image display method performed by the image display system 4 of the pinball machine 1 is now described with reference to FIG. 2 and FIGS. 3A and 3B. FIG. 2 is a flowchart showing image display process performed by the image display system 4, and FIGS. 3A and 3B illustrate virtual images produced by the frame buffer 46.

The image display system 4 executes image display process for displaying an image having performance pattern such as animated cartoon as window display image, and an arbitrary background image on the outer circumference of the window display image under the image display program stored in the memory (not shown) of the control unit 47 when the image display system 4 receives a predetermined control command from the main controller 3.

When the image display process is initiated, the display control section 473 commands the scaler 45 to stop outputting an image signal corresponding to an image stored in the frame buffer 46 (step S1).

When the output of the image by the scaler 45 is stopped, the background image transfer section 471 sets the horizontal cycle and vertical cycle of the image signal outputted from the GPU 43 at 1,408 pixels and 989 lines, respectively, and sets the resolution of the image produced by the GPU 43 at 1,280×960 (step S2).

Then, the background image transfer section 471 commands the GPU 43 to produce an entire background image B1 having resolution of 1,280×960 which is the same resolution as that of the display area of the display unit 41 based on the entire background image data stored in the CGROM 42, and transfer the entire background image B1 to the scaler 45 (step S3).

The scaler 45 having received the entire background image B1 from the GPU 43 commands the frame buffer 46 to produce a virtual image corresponding to the entire background image B1 in synchronization with the dot clock of the GPU 43 and the horizontal synchronous signal and vertical synchronous signal contained in the image signal outputted from the GPU 43 and store the virtual image as illustrated in FIG. 3A (step S4).

When the entire background image B1 is stored in the frame buffer 46, the window display image transfer section 472 sets the horizontal cycle and vertical cycle of the image signal outputted from the GPU 43 at 998 pixels and 618 lines, respectively, and sets the resolution of the image produced by the GPU 43 at 800×600 (step S5).

Then, the window display image transfer section 472 commands the GPU 43 to produce a window display image W1 having resolution of 800×600 which is smaller than the resolution of 1,280×960 as resolution of the display area of the display unit 41 based on the window display image data stored in the CGROM 42, and transfer the window display image W1 to the scaler 45 (step S6).

The scaler 45 having received the window display image W1 from the GPU 43 commands the frame buffer 46 to produce a virtual image corresponding to the window display image W1 in synchronization with the dot clock of the GPU 43 and the horizontal synchronous signal and vertical synchronous signal contained in the image signal outputted from the GPU 43 and store the virtual image (step S7). In this step, the window display image W1 is overwritten at a predetermined position of the entire background image B1 stored in the frame buffer 46. That is, the entire background image B1 and the window display image W1 are combined and stored in the frame buffer 46 as illustrated in FIG. 3B.

When the window display image W1 is stored in the frame buffer 46, the display control section 473 commands the scaler 45 to start outputting an image signal corresponding to the image stored in the frame buffer 46 (step S8). In this step, the resolution of the combined image of the entire background image B1 and the window display image W1 stored in the frame buffer 46 is 1,280×960. Since the resolution of the combined image is the same as the resolution of the display area of the display unit 41, the scaler 45 outputs the image signal corresponding to the image stored in the frame buffer 46 without adjustment of resolution.

When the image signal corresponding to the image data for one frame is outputted from the scaler 45, the control unit 47 judges whether the window display image W1 is updated or not (step S9). When it is judged that the window display image W1 is updated (step S9: Y), the control unit 47 again performs steps S6 to S9.

When it is judged that the window display image W1 is not updated (step S9: N), the control unit 47 judges whether the entire background image B1 is updated or not (step S10). When it is judged that the entire background image B1 is updated (step S10: Y), the control unit 47 again performs steps S1 through S10. When it is judged that the entire background image B1 is not updated (step S10: N), the control unit 47 ends the image display process.

By performing steps S1 to S10 discussed above, the image display system 4 can display the image having performance pattern such as animated cartoon as the window display image W1, and the arbitrary entire background image B1 on the outer circumference of the window display image W1.

The pinball machine 1 according to this embodiment can offer the following advantages.

(1) The control unit 47 has the background image transfer section 471, the window display image transfer section 472, and the display control section 473. Thus, the image signal corresponding to the entire background image B1 and the image signal corresponding to the window display image W1 can be separately transferred to the scaler 45 in a time-separated manner. Accordingly, the arbitrary entire background image can be displayed on the outer circumference of the window display image W1 by the inexpensive structure of the image display system 4 which includes only the GPU 43 as one device and the scaler 45 as a component having a single input system.

(2) The background image transfer section 471 commands the GPU 43 to produce the entire background image B1 having resolution determined in accordance with the resolution of the entire display area of the display unit 41. Thus, the produced entire background image can be transferred to the scaler 45 at a time. Then, the display control section 473 commands the scaler 45 to stop outputting the image signal corresponding to the image stored in the frame buffer 46 when the entire background image B1 is transferred from the background image transfer section 471. Thus, the display unit 41 can display not a disordered image but only a normal image.

(3) When the same image is stored in the frame buffer 46 for a long period of time, data associated with the stored image may be broken due to electrostatic noise or other effects. It is therefore preferable that the image stored in the frame buffer 46 is updated at predetermined time intervals. In this embodiment, the control unit 47 can update the image stored in the frame buffer 46 at predetermined time intervals by executing step S10.

### Second Embodiment

A pinball machine 1A according to a second embodiment of the invention is now described.

In the following description, similar reference numbers are given to similar parts, and the same explanation is not repeated.

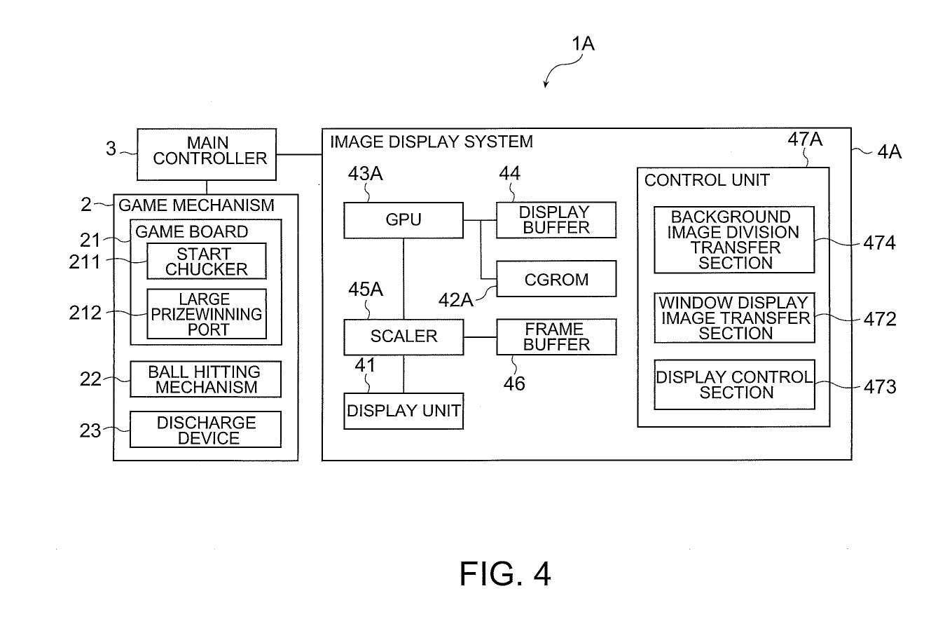

FIG. 4 is a block diagram showing a general structure of the pinball machine 1A.

The image display system 4 included in the pinball machine 1 according to the first embodiment has the background image transfer section 471 which commands the GPU 43 to produce the entire background image B1 having the same resolution as the resolution of the display area of the display unit 41 based on the entire background image data stored in the CGTROM 42 and transfer the entire background image B1 to the scaler 45. However, an image display system 4A included in the pinball machine 1A according to this embodiment is different from the image display system 4 in that the image display system 4A has a background image division transfer section 474 as shown in FIG. 4. The background image division transfer section 474 commands a GPU 43A to produce division background images created by dividing the entire background image B1 into a plurality of parts based on division background image data stored in a CGROM 42A, and sequentially transfer the division background images to a scaler 45A.

The CGROM 42A stores division background image data created by dividing entire background image data for an entire background image having the same resolution as the resolution in the entire display area of the display unit 41 into four parts, and window display image data for a window image displayed on a part of the display area of the display unit 41. More specifically, the division background image data is image data having resolution of 640×480 as one of four parts of the background image data having resolution of 1,280×960 as the resolution of the display area of the display unit 41.

The background image division transfer section 474 commands the GPU 43A to produce division background images corresponding division background image data stored in the CGROM 42A and sequentially transfer the division background images to the scaler 45A. More specifically, the background image division transfer section 474 sets the horizontal cycle and vertical cycle of the image signal outputted from the GPU 43A at 1,236 pixels and 498 lines, and sets the resolution of the image produced by the GPU 43A at 640×480. Then, the background image division transfer section 474 commands the GPU 43A to produce the division background images each of which has resolution of 640×480 as one of the four parts of the entire background image having resolution of 1,280×960 equal to the resolution of the display area of the display unit 41, and sequentially transfer the division background images to the scaler 45A. In this case, the refresh rate of the image associated with the image signal outputted from the GPU 43A is approximately 60 Hz.

The scaler 45A controls the resolution of the image associated with the inputted image signal and outputs the controlled resolution to the display unit 41. More specifically, the scaler 45A receives the division background images as four parts of the entire background image B1 sequentially transferred from the GPU 43A, and commands the frame buffer 46 to produce virtual images corresponding to the division background images and store the virtual images. In this step, the division background images each of which has the resolution of 640×480 are combined on the frame buffer 46. More specifically, the scaler 45A commands the frame buffer 46 to produce a virtual image of the entire background image B1 having the resolution of 1,280×960 prior to division into four parts and store the virtual image. Then, the scaler 45A adjusts the resolution of the image stored in the frame buffer 46, and produces an image signal corresponding to the image after resolution adjustment to be outputted to the display unit 41.

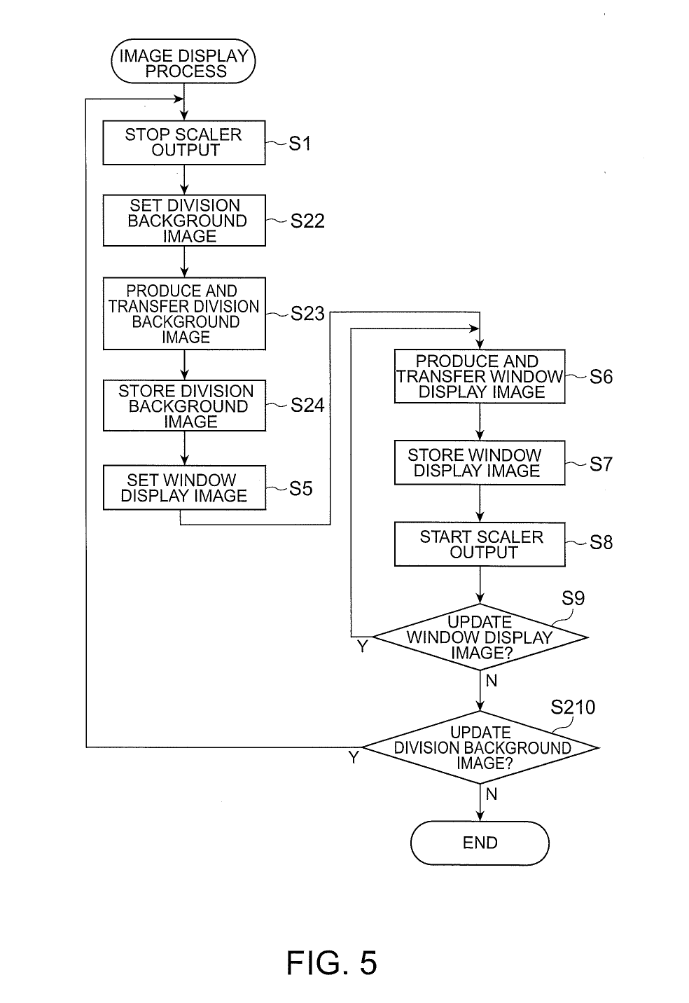

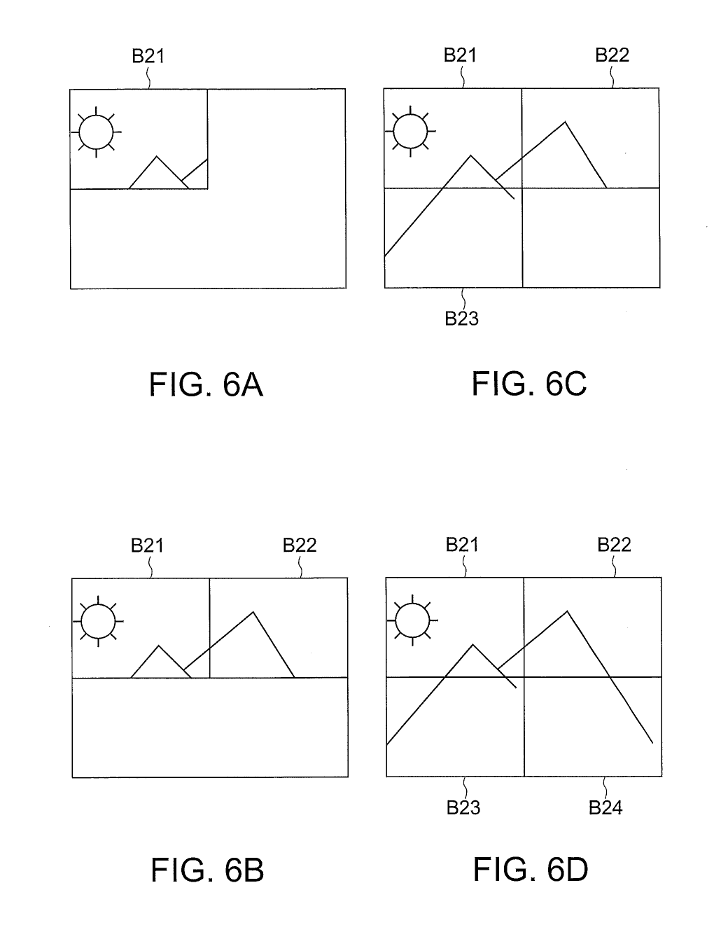

An image display method which uses the image display system 4A of the pinball machine 1A is now described with reference to FIG. 5 and FIGS. 6A to 6D. FIG. 5 is a flowchart showing image display process using the image display system 4A. FIGS. 6A to 6D show virtual images produced by the frame buffer 46.

The image display system 4A having received a predetermined control command issued from the main controller 3 executes image display process for displaying an image having performance pattern such as animated cartoon as a window display image, and an arbitrary background image on the outer circumference of the window display image.

When the image display process is initiated, the display control section 473 commands the scaler 45A to stop outputting an image signal corresponding to an image stored in the frame buffer 46 (step S1).

When the output of the image by the scaler 45A is stopped, the background image division transfer section 474 sets the horizontal cycle and vertical cycle of the image signal outputted from the GPU 43A at 1,236 pixels and 498 lines, and sets the resolution of the image produced by the GPU 43A at 640×480 (step S22).

Then, the background image division transfer section 474 commands the GPU 43A to produce division background images B21 through B24 corresponding to the division background image data stored in the CGROM 42A, and sequentially transfer the division background images B21 to B24 to the scaler 45A (step S23).

The scaler 45A having received the division background images B21 to B24 transferred from the GPU 43A commands the frame buffer 46 to produce virtual images corresponding to the division background images B21 to B24 in synchronization with the dot clock of the GPU 43A and the horizontal synchronous signal and vertical synchronous signal contained in the image signal outputted from the GPU 43A and store the virtual images (step S24). In this case, the division background images B21 through B24 each of which has resolution of 640×480 are sequentially combined on the frame buffer 46 as illustrated in FIGS. 6A to 6D.

More specifically, the background image division transfer section 474 initially commands the GPU 43A to produce the upper left division background image B21 corresponding to the division background image data located at the upper left position of the entire background image B1 stored in the CGROM 42A, and transfer the upper left division background image B21 to the scaler 45A. Then, the scaler 45A commands the frame buffer 46 to produce a virtual image corresponding to the upper left division background image B21 at the upper left position of the frame buffer 46 and store the virtual image thereat (see FIG. 6A).

Subsequently, the background image division transfer section 474 commands the GPU 43A to produce the upper right division background image B22 corresponding to the division background image data located at the upper right position of the entire background image B1 stored in the CGROM 42A, and transfer the upper right division background image B22 to the scaler 45A. Then, the scaler 45A commands the frame buffer 46 to produce a virtual image corresponding to the upper right division background image B22 at the upper right position of the frame buffer 46 and store the virtual image threat (see FIG. 6B).

Similarly, the background image division transfer section 474 commands the GPU 43A to sequentially transfer the lower left division background image B23 and lower right division background image B24 to the scaler 45A, and the scaler 45A commands the frame buffer 46 to produce virtual images corresponding to the lower left division background image B23 and lower right division background image B24 at the lower left position and lower right position of the frame buffer 46 and store the virtual images thereat (see FIGS. 6C and 6D).

When the division background images B21 to B24 are stored in the frame buffer 46, the image display system 4A performs steps S5 to S9 similarly to the case in the first embodiment.

When it is determined that the window display image W1 is not updated in step S9 (step S9: N), the control unit 47 judges whether the division background images B21 to B24 are updated or not (step S210). When it is determined that the division background images B21 to B24 are updated (step S210: Y), the control unit 47 again performs steps SI through S210. When it is determined that the division background images B21 to B24 are not updated (step S210: N), the control unit 47A ends the image display process.

In this embodiment, operation and advantage similar to those in the first embodiment can be provided. In addition, the following operation and advantage can be offered.

In this embodiment, the division background image data created by dividing the entire background image data into four parts are stored in the CGROM 42A in advance. Thus, the storage area of the CGROM 42A can be more effectively used than in the structure where large background image data is stored without division.

### MODIFIED EXAMPLES

The invention is not limited to the embodiments described herein, and it is therefore intended that modifications and improvements within the range offering the advantage of the invention are included in the scope of the invention.

According to the first and second embodiments, the resolution of the combined images of the entire background image B1 and the window display image W1 is 1,280×960 which is equal to the resolution of the display area of the display unit 41. Thus, the scaler 45 or 45A outputs the image signal corresponding to the image stored in the frame buffer 46 without adjustment of the resolution. It is possible, however, to command the image producing unit to produce a background image having resolution smaller than the resolution of the display area of the display unit and increase the resolution of the background image by the resolution adjusting unit, for example. In this case, the resolution of the window display image is increased with the same rate as the increase rate of the resolution of the background image. Thus, when the resolutions of the display area of the display unit and the background image are 1,280×960 and 1,024×768, respectively, the resolution of the background image is increased to 1.25 times larger resolution by the resolution adjusting unit. Thus, when the resolution of the window display image is 640×480, a window display image having resolution of 800×600 is displayed on the display area of the display unit.

According to the first and second embodiments, the display control section 473 commands the scaler 45 or 45A to stop outputting the image stored in the frame buffer 46 when the background image is transferred from the GPU 43 or 43A to the scaler 45 or 45A. It is possible, however, to command the resolution adjusting unit to output a monochrome image during this period, for example. Alternatively, when the time for transferring the background image from the image producing unit is short with little disturbance by a disordered image to be displayed on the display area of the display unit or in similar cases, the display control unit need not stop the output of the image stored in the virtual image storing unit.

According to the second embodiment, the CGROM 42A stores the division background image data created by dividing the entire background image data into four parts for displaying the entire background image having the same resolution as the resolution of the entire display area of the display unit 41. It is possible, however, to store division background image data created by dividing the entire background image into sixteen parts, for example. The only requirement is that division background image data created by dividing the background image data into a plurality of parts are stored in the image data storing unit in advance.

According to the second embodiment, the background image division transfer section 474 commands the GPU 43A to produce the division background images B21 to B24 corresponding to the division background image data stored in the CGROM 42A and sequentially transfer the division background images B21 to B24 to the scaler 45A. It is possible, however, that the image producing unit divides the background image data stored in the image data storing unit into a plurality of parts and extracts these parts to produce division background images.

While the image display system 4 or 4A is included in the pinball machine 1 or 1A in the first and second embodiments, the image display system 4 or 4A may be included in other game machines such as slot machine, or in other machines such as portable device and audio system. The image display system 4 or 4A is also applicable to image display apparatus such as liquid crystal television.

The image display system described and depicted herein is applicable to an image display apparatus, and particularly appropriate for an image display system included in a game machine.

What is claimed is:

1. An image display system, comprising:
a display unit which displays an image;
an image data storing unit which stores display image data;
an image producing unit which produces an image corresponding to the image data stored in the image data storing unit;
a virtual image storing unit which produces a virtual image corresponding to the image produced by the image producing unit and stores the virtual image;
a resolution adjusting unit which adjusts resolution of the image stored in the virtual image storing unit and outputs the adjusted image to the display unit; and
a control unit which controls the image producing unit and the resolution adjusting unit,
wherein
background image data for a background image displayed on a display area of the display unit and window display image data for a window image displayed on a part of the display area are stored in the image data storing unit, and
the control unit includes
a background image transfer section which commands the image producing unit to produce a background image corresponding to the background image data and transfer the background image to the resolution adjusting unit,
a window display image transfer section which commands the image producing unit to produce a window display image corresponding to the window display image data and transfer the window display image to the resolution adjusting unit, and
a display control section which controls the process of the resolution adjusting unit for outputting the image stored in the virtual image storing unit.

2. The image display system according to claim 1, wherein the background image transfer section commands the image producing unit to produce an entire background image having resolution determined according to the resolution of the entire display area of the display unit and transfer the entire background image to the resolution adjusting unit.

3. The image display system according to claim 1, wherein the background image transfer section commands the image producing unit to produce division background images created by dividing the background image and transfer the division background images to the resolution adjusting unit.

4. The image display system according to claim 1, wherein the display control section commands the resolution adjusting unit to stop the process for outputting the image stored in the virtual image storing unit when the background image is transferred by the image producing unit.

5. A game machine, comprising the image display system according to claim 1.

6. An image display method used for an image display system which includes:
a display unit which displays an image;
an image data storing unit which stores display image data;
an image producing unit which produces an image corresponding to the image data stored in the image data storing unit;
a virtual image storing unit which produces a virtual image corresponding to the image produced by the image producing unit and stores the virtual image;
a resolution adjusting unit which adjusts resolution of the image stored in the virtual image storing unit and outputs the adjusted image to the display unit; and
a control unit which controls the image producing unit and the resolution adjusting unit,
wherein
the control unit performs
a background image transfer step which produces a background image corresponding to the background image data for a background image displayed on a display area of the display unit and transfers the background image to the resolution adjusting unit,
a window display image transfer step which produces a window display image corresponding to the window display image data for a window image displayed on a part of the display area and transfers the window display image to the resolution adjusting unit, and
a display control step which controls the process of the resolution adjusting unit for outputting the image stored in the virtual image storing unit.

7. An image display program used for an image display system which includes:
a display unit which displays an image;
an image data storing unit which stores display image data;
an image producing unit which produces an image corresponding to the image data stored in the image data storing unit;
a virtual image storing unit which produces a virtual image corresponding to the image produced by the image producing unit and stores the virtual image;
a resolution adjusting unit which adjusts resolution of the image stored in the virtual image storing unit and outputs the adjusted image to the display unit; and
a control unit which controls the image producing unit and the resolution adjusting unit,
the program allowing the control unit to perform:
a background image transfer step which produces a background image corresponding to the background image data for a background image displayed on a display area of the display unit and transfers the background image to the resolution adjusting unit,
a window display image transfer step which produces a window display image corresponding to the window display image data for a window image displayed on a part of the display area and transfers the window display image to the resolution adjusting unit, and
a display control step which controls the process of the resolution adjusting unit for outputting the image stored in the virtual image storing unit.

8. A storage medium on which the image display program according to claim 7 is recorded in such a manner as to be readable by a computer.
